(19) United States
(12) Patent Application Publication
(10) Pub. No.: US 2016/0110319 A1
(43) Pub. Date: Apr. 21, 2016

(54) URI Font in print material processing method and apparatus thereof

(71) Applicants: NIRNAY BANSAL, PFLUGERVILLE, TX (US); DHARNA GUPTA, PFLUGERVILLE, TX (US)

(72) Inventors: NIRNAY BANSAL, PFLUGERVILLE, TX (US); DHARNA GUPTA, PFLUGERVILLE, TX (US)

(21) Appl. No.: 14/520,136

(22) Filed: Oct. 21, 2014

(51) Int. Cl. G06F 17/21; G06K 9/46; G06K 9/52; G06K 9/62

(52) U.S. Cl. CPC G06F 17/214; G06K 9/6212; G06K 9/4661; G06K 9/4647; G06K 9/52

(57) ABSTRACT

A URI (Uniform Resource Identifier) Font is a combination of Font, binarized coded image and a decoding processing process. The ornamental design for a type font, as shown and described. The decoding processing process converts binarized coded image (with each font) into valid URI Character by identifying a plurality of luminance groups according to luminance values of pixels within an input binarized coded image.

### BACKGROUND OF THE INVENTION

1. Field of the Invention

The present invention generally relates to optical character recognition systems and more particularly to those systems which are utilized to automatically read symbols or alpha-numeric type characters which have been printed, embossed or otherwise formed on documents. The present includes features within Font which enhance the effective optical contrast of the binary patterns representing the characters, locate the characters within a prescribed binarized coded image area (with each font), and recognize the characters.

2. Description of the Prior Art

For printing and publishing activities such as but not limited to newspaper, books, magazine, marketing fliers, advertisement material, a URI is provides a fast and convenient method to give more information to users. However, in our rapidly modernizing society, typing URI in electronic media is gradually becomes inefficient. Long URI are almost impossible to type in electronic devices correctly by reading printed and published material such as but not limited to newspaper, books, magazine, marketing fliers and advertisement material, and thus ignored by the users.

### SUMMARY OF THE INVENTION

A general objective of the present invention is to overcome the aforesaid problems and provide an apparatus including an URI Font with binarized code that can be printed on any printed and published material such as but not limited to newspaper, books, magazine, marketing fliers and advertisement material.

Another object of my invention is to provide an apparatus of the foresaid type that can read a large number of URI Font characters rapidly, which will instantaneously produce outputs corresponding to these characters in the form of a URI on electronic device.

The invention described hereinafter pertains to combination of URI Font which is a combination of Font, binarized code with a decoding processing process. The ornamental design for a type font, as shown and described. The URI Font can be used in printing and publishing activities such as but not limited to newspaper, books, magazine, marketing fliers, and advertisement material. The decoding processing process converts binarized coded image (with each font) into valid URI Character by identifying a plurality of luminance groups according to luminance values of pixels within an input binarized coded image.

In General URIs (Uniform Resource Identifier) as defined by RFC 3986 (see Section 2: Characters) may contain any of the following characters:

A B C D E F G H I J K L M N O P Q R S T U V W X Y Z
a b c d e f g h i j k l m n o p q r s t u v w x y z
0 1 2 3 4 5 6 7 8 9

| | |
|---|---|
| sub-delims | ! |
| gen-delims | # |
| sub-delims | $ |
| sub-delims | & |
| sub-delims | ' |
| sub-delims | ( |
| sub-delims | ) |
| sub-delims | * |
| sub-delims | + |
| sub-delims | , |
| unreserved | - |
| unreserved | . |
| gen-delims | / |
| gen-delims | : |
| sub-delims | ; |
| sub-delims | = |
| gen-delims | ? |
| gen-delims | @ |
| gen-delims | [ |
| gen-delims | ] |
| unreserved | _{—} |
| unreserved | ~ |

Understating URI is out of our scope.

According to a first embodiment of the present invention, a processing method of URI Font is provided. The URI Font process comprises Font, binarized code and a decoding processing process. The ornamental design for a type font, as shown and described. The decoding processing procedure converts an original binarized image given with each URI font to derive a character. The decoding processing process comprises an Image block Luminance Group and a Comparing Unit. The Image block Luminance Group procedure determines the edge of an input image. The comparing unit procedure derives a plurality of image block Luminance value into either dark image blocks or white (bright) image blocks and give a binary number of 1 or 0 respectively.

The present invention therefore provides a URI Font a combination of Font, binarized code and a decoding processing process method and an apparatus thereof, which can effectively derive a plurality of URI Character within plurality of an input image. In addition, the present invention is capable of further adjusting the URI Font such that it can be decoded and processed by following processing apparatus more easily.

These and other objectives of the present invention will no doubt become obvious to those of ordinary skill in the art after reading the following detailed description of the preferred embodiment that is illustrated in the various figures and drawings

### BRIEF DESCRIPTIONS OF THE DRAWING

FIG. 1 is a face view of the capital letters of the type font according to the present invention.

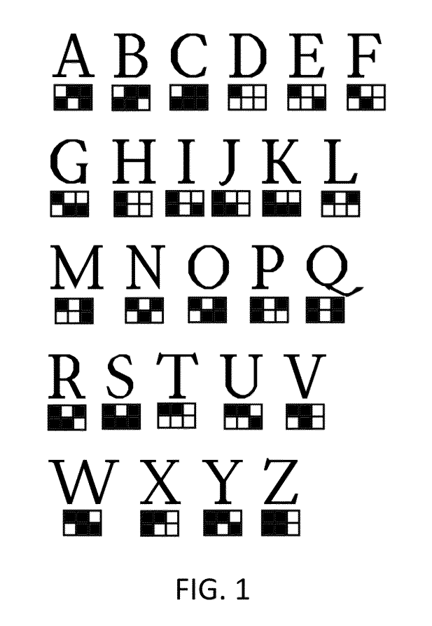

FIG. 2 is a face view of the small letters of the type font according to the present invention.

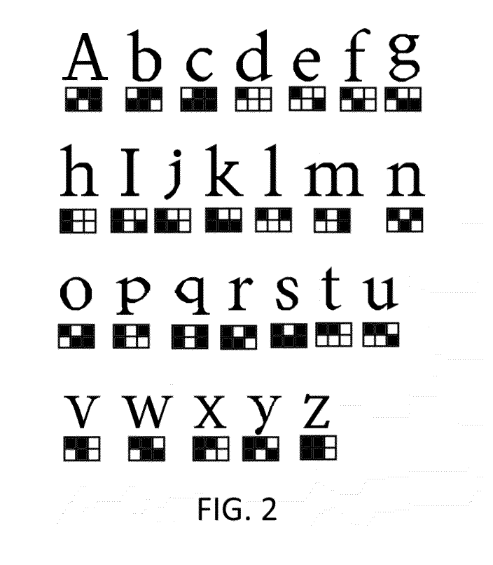

FIG. 3 is a face view of the numbers of the type font according to the present invention.

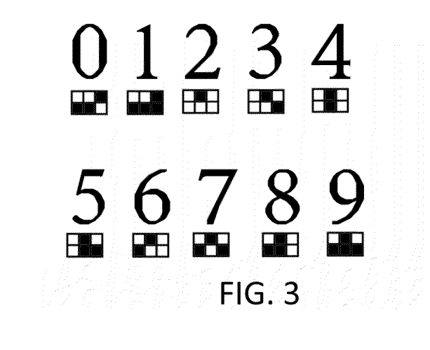

FIG. 4 is a face view of the symbols of the type font according to the present invention.

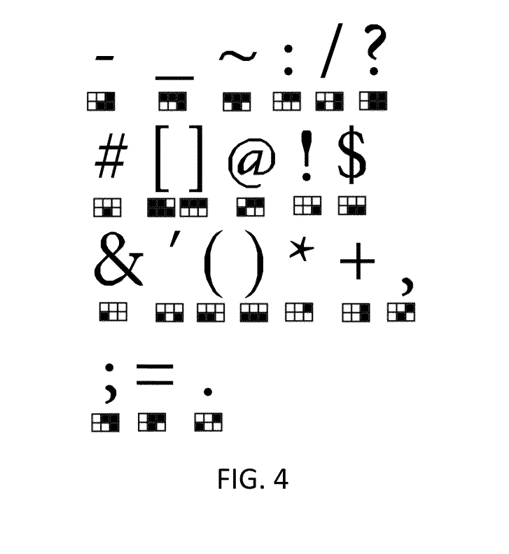

FIG. 5 is a face view showing the letters, number and symbols of the type font in use. The uri form no part of the claimed design.

FIG. 6 is an exemplary diagram of binarized coded image

FIG. 7 is an exemplary diagram of dark image block having luminance value of 1.

FIG. 8 is an exemplary diagram of white (bright) image block having luminance value of 0.

FIG. 9 is an exemplary block diagram of the decoding processing apparatus according to the one embodiment of the present invention.

FIG. 10 is an exemplary operation flowchart of the decoding processing shown in FIG. 5.

FIG. 11 is an exemplary operation Comparison chart.

The broken lines form no part of the claimed design. The Shape of Font form no part of the claimed design. The Size of Font form no part of the claimed design.

### DETAILED DESCRIPTION

According to embodiment of the present invention,

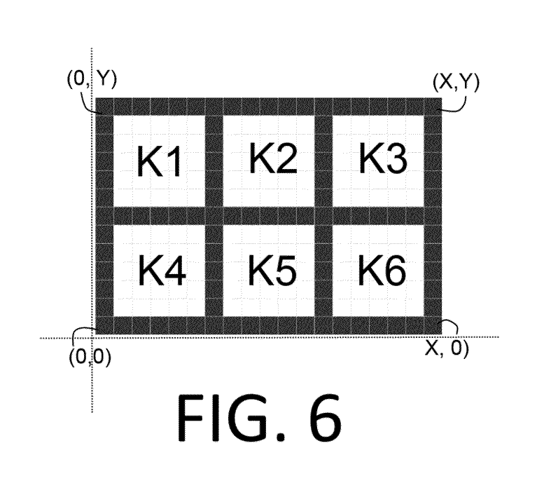

FIG. 6 is an operation diagram of the binarized coded image according to an embodiment of the present invention. In this embodiment, the image blocks K1-K6 are part of the timing patterns, in other words, image blocks K1-K6 are known image blocks (i.e., the image blocks which have been processed), wherein the image block can be dark image blocks or white (bright) image blocks.

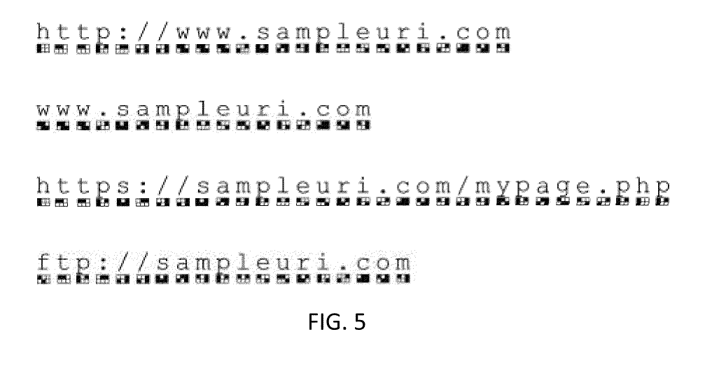

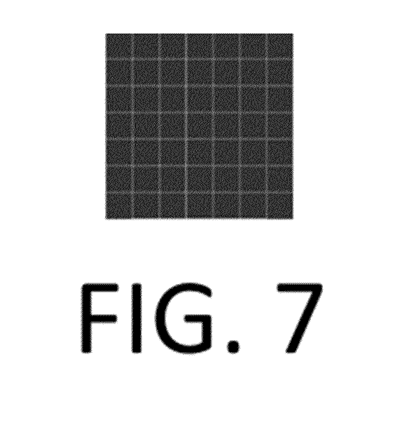

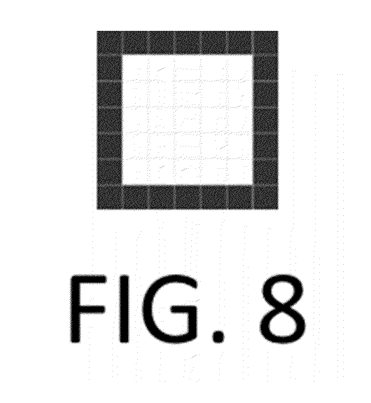

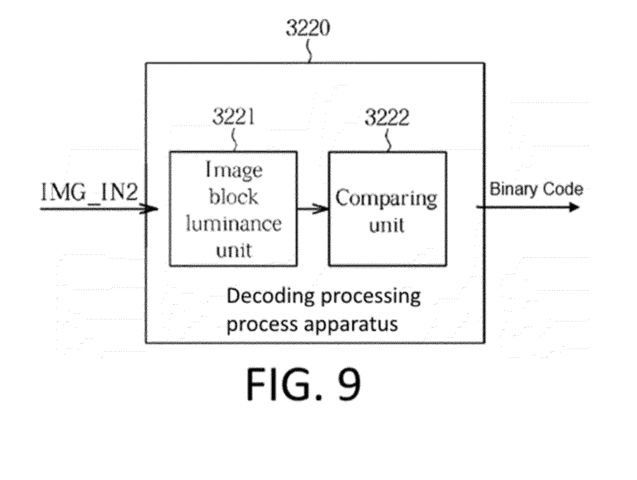

FIG. 9 is a decoding processing process apparatus 3220 is disclosed to convert an input image IMG_IN2 into a URI Character, wherein the input image IMG_IN2 comprises a plurality of image blocks which are basic units for decoding the URI Font, i.e., the smallest black/white grid within the URI Font. The image block Luminance unit module 3221 finds the reference points X, Y to assign the specific all image block such that the reference point X and Y is assigned a coordinates (0,Y) (X,Y) (0,0) and (X,0). In FIG. 5, the image blocks K1, K3, K4 and K6 have reference points n_K1 (whose coordinate is (0, Y)), n_K3 (whose coordinate is (X, Y)), n_K4 (whose coordinate is (0, 0)), and n_K6 (whose coordinate is (X, 0)) respectively. In this way, the image block luminance unit 3221 can derive coordinates of all reference points of all image blocks within the binarized coded image of URI Font. The comparison unit 3222 chooses a specific image block within the data area of the URI Font. The comparison unit 3222 derives a reference luminance value according to a plurality of image block luminance values of the known image blocks, and determines whether the specific image block is a white (bright) image block FIG. 8 or a dark image block FIG. 7 according to the reference luminance value and an image block luminance value of the specific image block. When the image block luminance value of the specific image block is larger than the reference luminance value, the comparing unit 3222 can determine that the specific image block is a white (bright) image block; otherwise, when the image block luminance value of the specific image block is lower than the reference luminance value, the comparing unit 3222 can determine that the specific image block is a dark image block. All dark image block FIG. 7 will be given luminance values of 1 and all white (bright) image block FIG. 8 will be give luminance values of 0. The corresponding value then be used in following formula (1):

Binary Code=K1 luminance values+K2 luminance values+K3 luminance values+K4 luminance values+K5 luminance values+K6 luminance values (12)

From equation (12), the comparing unit 3222 will calculate a Binary code with luminance value 1 and luminance value 0.

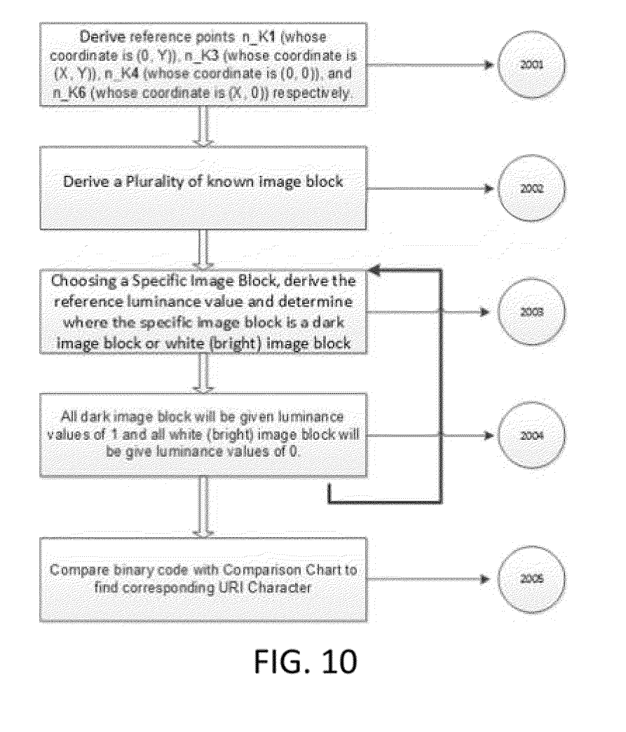

Please refer to FIG. 10 for a further illustration of an operation flowchart of the decoding processing process apparatus 3220.

In FIG. 10, Firstly, step 2001 derive reference points n_K1 (whose coordinate is (0, Y)), n_K3 (whose coordinate is (X, Y)), n_K4 (whose coordinate is (0, 0)), and n_K6 (whose coordinate is (X, 0)) respectively.

Next, step 2002 derives a plurality of known image blocks.

Next, for each image block within the URI Font, step 2003 derives an image block luminance value corresponding to the image block according to luminance values of all pixels of the image block within the URI Font. Step 2003 determines whether the specific image block is a bright image block or a dark image block according to the reference luminance value.

Next, in step 2004, all dark image block will be given luminance values of 1 and all white (bright) image block will be give luminance values of 0. The corresponding value then be used.

Next, in step 2005, a Comparison chart used to decoding the valid URI Character and form the URI.

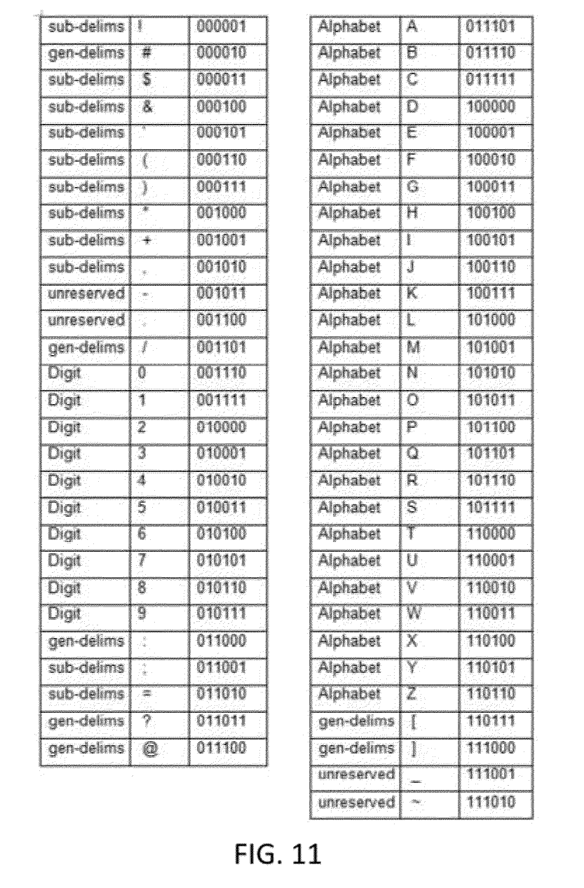

FIG. 11 is a Comparison chart used by the comparison unit 3222 to decoding the valid URI Character and form the URI. For example if Binary Code of Equation (12) decoded 110011 then this Binary Code of Equation (12) will generate character W from the FIG. 12

To summarize, the present invention provides a URI Font is a combination of Font, binarized code and a decoding processing method capable of capturing a URI Characters within an input image. In addition the present invention can further adjust the URI Font such that the URI Font can be decoded and processed more easily by following processing apparatus.

Those skilled in the art will readily observe that numerous modifications and alterations of the device and method may be made while retaining the teachings of the invention.

1. A URI (Uniform Resource Identifier) Font is a combination of Font, binarized code and a decoding processing process.

2. The binarized code of URI Font comprising a plurality of image blocks for each character.

3. A processing method of URI Font, for converting binarized code blocks (with each font) into valid URI Character. The decoding processing process comprising:
an image block Luminance unit module, comprising:
deriving plurality of image block of the binarized coded image (below each font);
an Comparing unit module, comprising:
for each image block within the plurality of image blocks:
deriving an image block luminance value for plurality of image block, and determining whether the specific image block is a bright image block or a dark image block according to the reference luminance value;
when the specific image block is a bright image block:
calculate Binary number 0;
when the specific image block is a dark image block:
calculate Binary number 1; and
add all image block Binary number; and
compare the Binary number with a comparison chart and convert
Binary number into corresponding URI character; and repeating the procedure until each URI Font finished.
